(19) United States
(12) Patent Application Publication
(10) Pub. No.: US 2007/0171556 A1
(43) Pub. Date: Jul. 26, 2007

(54) Method and apparatus for high power diode laser incoherent beam combination utilizing an image rotating beam combining element

(75) Inventors: Brian O'Neal Faircloth, Ballwin, MO (US); Mike Gall, St. Charles, MO (US); Mark Zediker, St. Charles, MO (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NUVONYX, INC., Bridgeton, MO (US)

(21) Appl. No.: 11/655,983

(22) Filed: Jan. 22, 2007

Related U.S. Application Data
(60) Provisional application No. 60/760,396, filed on Jan. 20, 2006.

(51) Int. Cl. G02B 5/04

(52) U.S. Cl. 359/834; 369/110.02

(57) ABSTRACT

A prism includes a plurality of internal surfaces that reflect a beam incident on the prism.

### BACKGROUND OF THE INVENTION

1. Field of the Invention

The present invention generally relates to a method and apparatus for high power diode laser systems, and more particularly to a method and apparatus for combining the beams from a plurality of diode laser sources to form one beam whose optical quality is representative of one element but contains the total power of all of the elements.

2. Description of the Related Art

A semiconductor laser is based on the generation and amplification of light in a forward biased p-n junction diode that is fabricated in a material that possesses the correct set of properties required to emit photons such as, but not limited to, gallium arsenide (GaAs). The individual diodes can emit powers greater than 1 W. In order to use these devices to build laser systems with emission powers greater than 1 kW, the beams emitted from multiple diode lasers must be combined into a single beam.

Most commonly, the diode lasers are packaged and arranged in such a way that their light is coupled into an optical fiber for applications such as, but not limited to, material processing and optical pumping of other active optical elements. The method by which the beams are combined from the multiple diode laser elements determines the efficiency of the overall system and the quality of the final beam. These metrics determine the viability of the laser system for many applications and therefore its success in the industry.

One such method for this beam combination involves the overlapping of two beams that have polarizations that are orthogonal to each other. The beams are combined using an optical element that reflects one polarization and passes the other polarization. The design and manufacture of this element is common with today's art.

Another method is to combine two sets of diode lasers that have different wavelengths or colors. The beams are combined using an optical element that reflects one wavelength and passes the other wavelength.

In order to combine two diode lasers or stacks of diode lasers with the same polarization, the polarization of one diode laser or stack must be rotated orthogonal to its original polarization. The common optical element employed to accomplish this task is made from an anisotropic medium and is usually referred to as a half-wave plate. This element rotates the polarization but preserves the image of the beam.

These two optical elements, the half-wave plate and polarization dependant reflector, in concert, form the common embodiment of a polarization beam combining system. The color or wavelength combining system only requires the color dependant reflector.

Conventional methods suffer because they are highly wavelength dependent. The thickness of the waveplate is manufactured to match the wavelength passing through it. The waveplate works at only a single wavelength.

### SUMMARY OF THE INVENTION

In view of the foregoing and other exemplary problems, drawbacks, and disadvantages of the conventional methods and structures, an exemplary feature of the present invention is to provide a method and structure in which the beams from multiple diode lasers are combined together to form one beam.

In accordance with a first aspect of the present invention, a prism includes a plurality of internal surfaces that reflect a beam of light that is incident on the prism.

In accordance with a second aspect of the present invention an optical element includes a glass prism.

In accordance with a third aspect of the present invention a laser system includes at least one laser producing an output beam and an image rotating prism that rotates the output beam, which is incident on the image rotating prism.

Accordingly, the present invention rotates the direction of propagation, polarization, and image of a group of laser beams emitted by one or a plurality of laser diodes in a 1-dimensional or 2-dimensional configuration. When the invention is used in conjunction with a polarizing beam combining element and/or a color combining element, the system acts as an incoherent beam combiner, which improves the brightness of a diode laser system.

Furthermore, the polarization remains co-parallel to the image throughout the rotation. This is not the case with a dove prism image rotator.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIGS. 1A and 1B illustrates a two-dimensional view of a glass prism in accordance with an exemplary embodiment of the present invention;

FIG. 2 illustrates an isometric view of the glass prism with light and an image propagating through the glass prism 100; and

FIG. 3 illustrates a laser system 300 using the prism 100 in accordance with an exemplary embodiment of the present invention.

### DETAILED DESCRIPTION OF EXEMPLARY EMBODIMENTS OF THE INVENTION

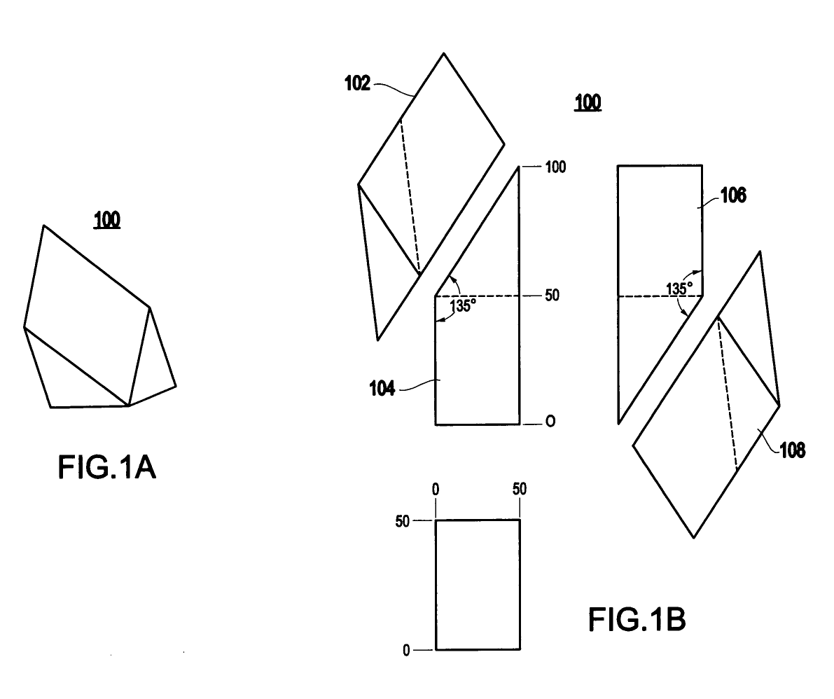

Referring now to the drawings, and more particularly to FIGS. 1A-3, there are shown exemplary embodiments of the method and structures according to the present invention.

FIGS. 1A. 1B and 2 illustrate a solid glass prism 100 in accordance with certain exemplary embodiments of the present invention. The glass prism 100 used to redirect a beam generated by one or a plurality of laser diodes. The prism 100 serves as a nearly lossless optical element, which replaces two of the optical elements, a half wave plate and a mirror, that are required in a conventional polarization beam combining system. Each of the conventional components are mounted and aligned individually, unlike the image rotating prism 100 of the present invention, which is manufactured as a single optic. This simplifies the overall optical design and therefore, the system assembly.

The prism 100 is designed and built to make use of total internal reflection (TIR). The light enters perpendicular to the entrance surface which is coated with an anti-reflection (AR) coating to minimize loss at that surface. The beam is reflected by two internal surfaces that are angled at 45° with respect to the incident beam. The light then exits the prism at another perpendicular surface with a direction of propagation that is 90° with respect to the entrance beam. The two reflections that occur internally in the prism rotate the image of the entrance beam and its polarization.

The rotation of the image is particularly beneficial to diode laser systems that are coupled into a glass fiber for beam delivery. Since diode lasers generate a beam with an astigmatism, more power is generally outside of the acceptance angle of the fiber in one axis than the other. In conventional polarization beam combining apparatuses, the image is not rotated and the uncoupled power from two beams must be mitigated in one axis. The rotated combination equally spreads this power in two axes, reducing the stress caused by a non-uniform intensity on the mitigation mechanism.

The change in beam propagation by 90° allows for the combination of two beams that originate and propagate parallel with respect to each other. The beams do not need to originate perpendicular to each other or require a turning mirror which reduces the overall footprint and complexity of the laser system optics.

FIG. 1B illustrates the surfaces of the prism 100. The prism includes internal surfaces 102, 108. The prism also includes an external input surface 104 and an external output surface 106.

FIG. 3 illustrates a laser system 300 in accordance with an exemplary embodiment of the present invention. The laser system includes a first array 302 (e.g., a 808 nm laser array) and a second array 304 (e.g., a 808 nm laser array). The first array 302 emits a first light output 310, which has, for example, a p-polarization. The second array 304 emits a second light output 312, which has, for example, a p-polarization.

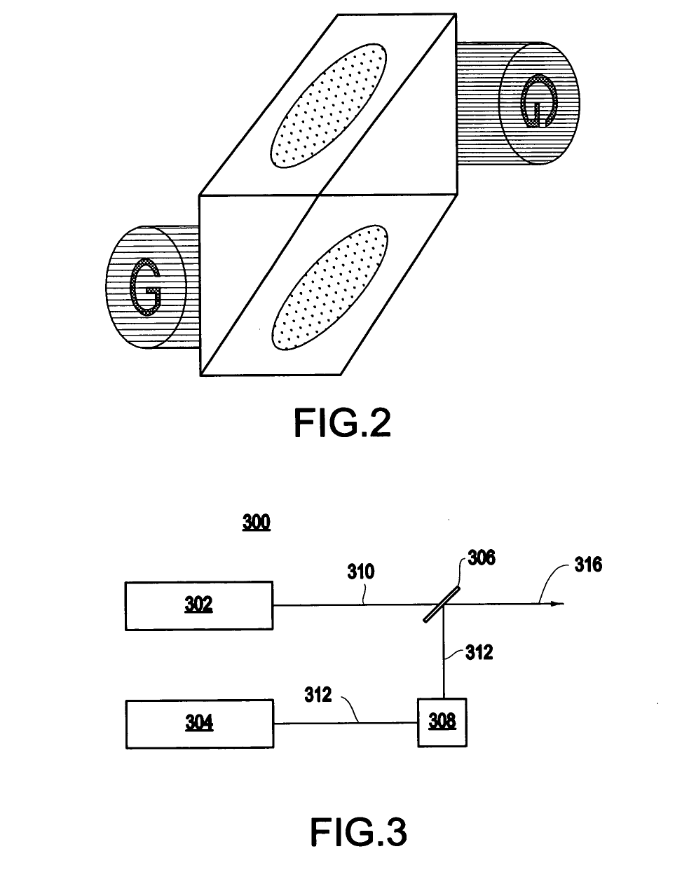

The second light out put 310 passes through a prism 308 (e.g., a prism in accordance with the exemplary embodiments depicted in FIGS. 1A, 1B and 2). The output 312 from the prism, which has s-polarization, is combined with the first light output 310 using a polarization combiner 306. As a result, a final light output 316 is emitted from the laser system 300 having p and s-polarization.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A prism, comprising:
a plurality of internal surfaces that reflect a beam incident on the prism.

2. The prism according to claim 1, wherein said internal surfaces are angled at 45°.

3. The prism according to claim 1, further comprising an external entrance surface and an external exit surface.

4. The prism according to claim 3, wherein at least one of said external entrance surface and said external exit surface is coated with an anti-reflection coating.

5. The prism according to claim 3, wherein said external entrance surface and said external exit surface are arranged perpendicular to an angle of incidence of the beam incident on the prism.

6. The prism according to claim 1, wherein the prism is a single optic element.

7. An optical element, comprising:
a prism.

8. The optical element according to claim 7, wherein the optical element is devoid of a half-wave plate and a mirror.

9. The optical element according to claim 7, wherein said prism comprises a plurality of internal surfaces that reflect a beam incident on the prism.

10. The optical element according to claim 9, wherein said internal surfaces are angled at 45°.

11. The optical element according to claim 7, wherein said prism comprises an external entrance surface and an external exit surface.

12. The optical element according to claim 11, wherein at least one of said external entrance surface and said external exit surface is coated with an anti-reflection coating.

13. The optical element according to claim 7, wherein said prism is a single optic element.

14. A laser system, comprising:
at least one laser producing an output beam; and
an image rotating prism that rotates the output beam, which is incident on said image rotating prism.

15. The laser system according to claim 14, further comprising at least one of a polarizing beam combining element and a color combining element.

16. The laser system according to claim 14, wherein the laser system is devoid of a half-wave plate and a mirror.

17. The laser system according to claim 14, wherein said image rotating prism comprises a plurality of internal surfaces that reflect a beam incident on the prism.

18. The laser system according to claim 17, wherein said internal surfaces are angled at 45°.

19. The laser system according to claim 14, wherein said prism comprises an external entrance surface and an external exit surface.

20. The laser system according to claim 20, wherein at least one of said external entrance surface and said external exit surface is coated with an anti-reflection coating.
